(19) United States
(12) Patent Application Publication
(10) Pub. No.: US 2006/0169204 A1
(43) Pub. Date: Aug. 3, 2006

(54) Substrate treating apparatus

(76) Inventor: Hwan-Suk Ju, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/345,225

(22) Filed: Feb. 2, 2006

(30) Foreign Application Priority Data
Feb. 2, 2005 (KR) 2005-09533

(51) Int. Cl. B05B 1/28

(52) U.S. Cl. 118/326; 118/684

(57) ABSTRACT

A substrate treating apparatus includes a process chamber and an exhaust member for exhausting reactive byproducts from the process chamber. The exhaust member includes a first exhaust line perpendicularly connected to the bottom of the process chamber and a second exhaust line branching at an angle from the first exhaust line. A switch valve and a flow control valve are mounted on the second exhaust line.

### BACKGROUND OF THE INVENTION

1. Field of the Invention

Embodiments of the invention relate to a substrate treating apparatus. More particularly, embodiments of the invention relate to a substrate treating apparatus having an exhaust pipe connected to a device where a deposition process is performed and configured for exhausting reactive byproducts.

This application claims priority of Korean Patent Application No. 2005-09533, filed on Feb. 2, 2005, the subject matter of which is hereby incorporated by reference in its entirety.

2. Description of Related Art

Conventional semiconductors are fabricated through a sequence of processes adapted to deposit, pattern, and clean various material layers formed on a substrate. Substrates are most commonly formed from silicon wafers. Many of the fabrication processes used to form a semiconductor device on a silicon wafer are performed in specialized process chambers. Process chambers are commonly employed to provide the controlled environments required to accurately deposit, pattern and clean the materials layers forming the semiconductor device. Process chambers also capture the often toxic reactive gases used in various fabrication processes, as well as the byproducts that result from the fabrication processes. Residual process gases and reactive byproducts are removed from the process chamber following completion of the fabrication process through an exhaust line.

A conventional arrangement is illustrated in FIG. (FIG.) 1, in which an exhaust line 720 is perpendicularly coupled to the bottom of a process chamber 710 in order to readily exhaust reactive byproducts. A switch valve 730 and a flow control valve 740 are sequentially installed along the length of exhaust line 720.

The conventional switch valve 730 is shown in some additional detail in FIG. 2. Here, switch valve 730 includes a body 732 coupled with exhaust line 720 and a cutoff plate 734 moving horizontally across the width of perpendicularly connected exhaust line 720 by means of an actuating cylinder. A holding space 736 is provided within body 732 to receive and hold cutoff plate 734 when exhaust line 720 is open.

Flow control valve 740 is illustrated in some additional detail in FIG. 3. Flow control valve 740 includes a body 742 and a rotation plate 744. When flow control valve 740 is mated to exhaust line 720, rotation plate 744 rotates within a valve space 746 of body 742 to constrain the flow of gas through flow control valve 740. That is, the allowing passage of gas or fluid through body 742 varies with the angle of rotation plate 744.

Unfortunately, the above-described, conventional combination of elements suffer from a number of problems. For example, the reactive byproducts exhausted from process chamber 710 may collect on the sidewalls of holding space 736 and/or on cutoff plate 734 as they pass through switch valve 730. At some point, deposited reactive byproducts may prevent normal operation of cutoff plate 734.

Additionally, when the inside of process chamber 710 is cleaned, during which time frame switch valve 730 and flow control valve 740 are normally closed, reactive byproducts particles removed from the inner sidewalls of process chamber 710 during the cleaning process, will drop onto cutoff plate 734 of switch valve 730 and/or rotation plate 744 of flow control valve 740. Such grit-like contamination from reactive byproducts may adhere to cutoff plate 734 and prevent its normal operation. Similarly, reactive byproducts attached to the edge of rotation plate 744 may prevent accurate pressure control where, for example, a low flow rate is desired through control valve 740. Edge particle contamination “P” of rotation plate 744 is illustrated in FIG. 4.

### SUMMARY OF THE INVENTION

Embodiments of the present invention are directed to a substrate treating apparatus.

In one embodiment, the invention provides a substrate treating apparatus comprising; a process chamber, and an exhaust member coupled to the process chamber and adapted to exhaust reactive byproducts from the process chamber. The exhaust member comprises; a first exhaust line connected to and extending from the bottom of the process chamber, a second exhaust line coupled at an angle to the first exhaust line, and a valve assembly mounted on the second exhaust line and adapted to open and close a flow path within the second exhaust line or control a flow rate for fluid flowing along the flow path.

In another embodiment, the invention provides a substrate treating apparatus comprising; a process chamber adapted to perform a deposition process, and an exhaust member adapted to exhaust reactive byproducts from the process chamber. The exhaust member comprises; a first exhaust line connected to and extending vertically from the bottom of the process chamber, a second exhaust comprising; a first line connected at a right angle to the first exhaust line and extending horizontally, and a second line connected at a right angle to the first line and extending vertically to a pump installed thereon, and a valve assembly mounted on the second exhaust line and adapted to open/close a flow path along the second exhaust line.

### BRIEF DESCRIPTION OF THE DRAWINGS

FIG. 1 is a cross-sectional view of a conventional exhaust line assembly connected to a process chamber.

FIG. 2 is a cross-sectional view further illustrating the switch valve illustrated in FIG. 1.

FIG. 3 and FIG. 4 are views further illustrating the flow control valve illustrated in FIG. 1.

FIG. 5 is a cross-sectional view of a substrate treating apparatus according to one embodiment of the invention.

FIG. 6 is a cross-sectional view illustrating one embodiment of a switch valve adapted for use in the apparatus illustrated in FIG. 5.

FIG. 7 is a cross-sectional view illustrating another embodiment of a switch valve adapted for use in the apparatus illustrated in FIG. 5.

FIG. 8 is a cross-sectional view further illustrating one embodiment of a flow control valve adapted for use in the apparatus illustrated in FIG. 5.

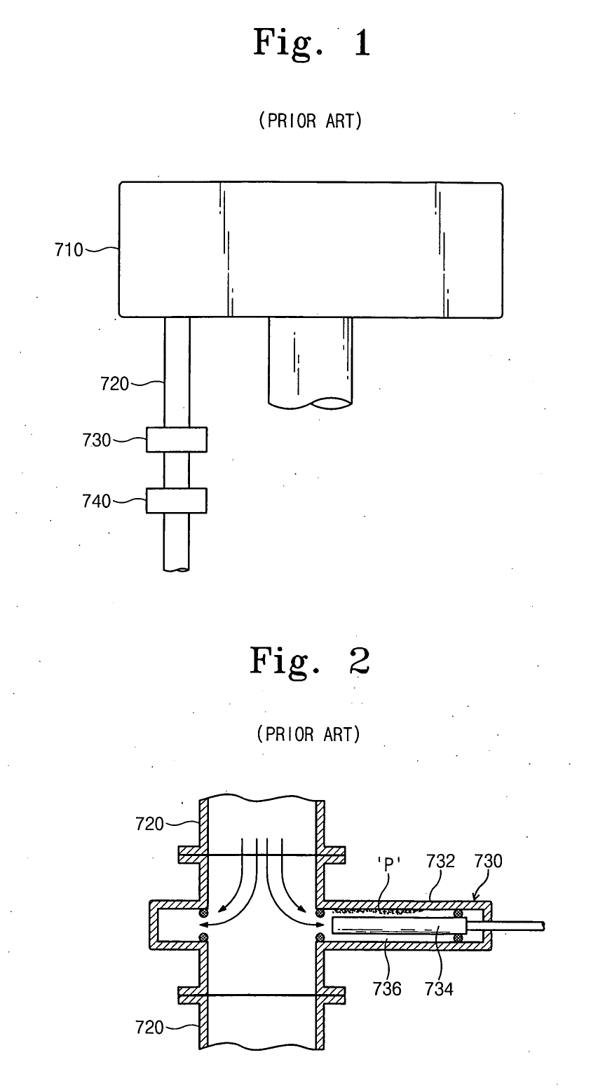

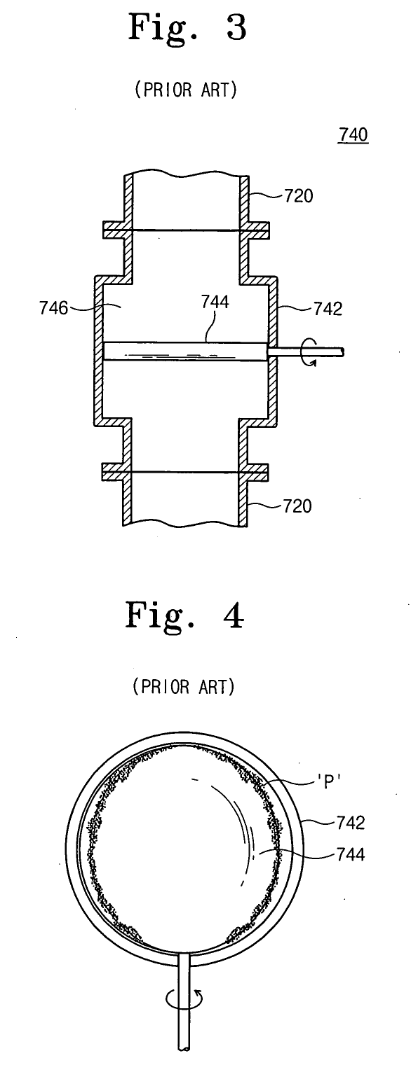

### DETAILED DESCRIPTION OF THE INVENTION

Several embodiments of the invention will now be described with reference to the accompanying drawings. The invention may, however, be embodied in many different forms and should not be construed as being limited to only the embodiments set forth herein. Rather, these embodiments are provided as teaching examples. In the drawings, the size and relative scale of related elements may be exaggerated for clarity.

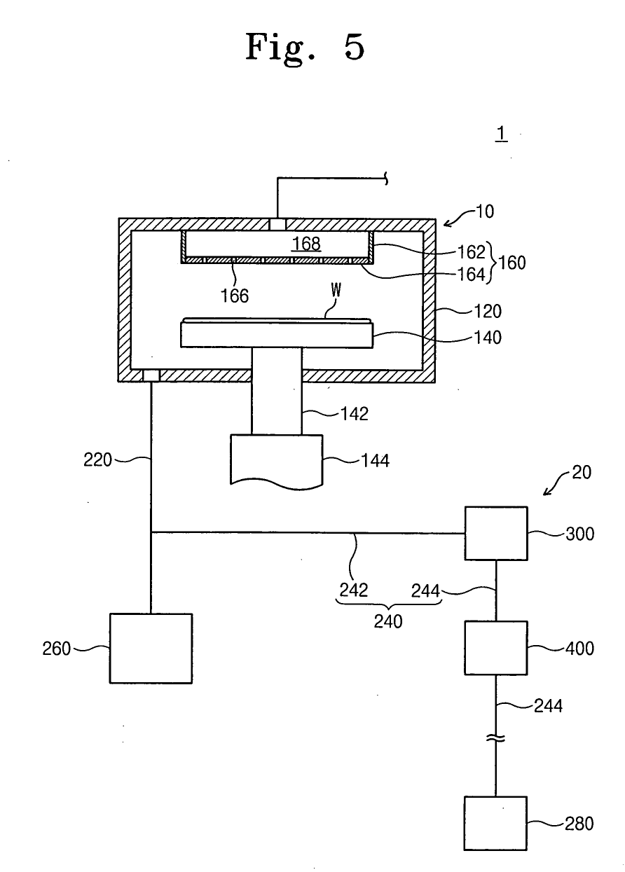

As illustrated in FIG. 5, a substrate treating apparatus 1 according to one embodiment of the invention generally comprises a process chamber 10 and an exhaust member 20. Process chamber 10 is sealed from the outside and offers a space in which a predetermined semiconductor fabrication process may be performed. This predetermined process may be, for example, a deposition process by which thin films of a material such as aluminum oxide (Al₂O₃) may be formed on a silicon wafer “W”. In the illustrated example, process chamber 10 comprises a support plate 140 disposed at a lower portion in process chamber 10. Wafer W is placed on support plate 140, and support plate 140 holds wafer W by means of mechanical clamping, electrostatic force, or vacuum pressure. A support axis 142 rotated by a motor 144 is coupled with support plate 140, so that support plate 140 may be rotated during the fabrication process. An injection member 160 is disposed at an upper portion in process chamber 10 generally opposite support plate 140. Injection member 160 comprises a ring-shaped side plate 162 and an injection plate 164 disposed on the bottom of side plate 162. Side plate 162 is mated with the top of process chamber 10 and a plurality of holes 166 are provided in injection plate 164. Deposition gas is injected towards wafer W through the plurality of holes formed in injection plate 164 from a gas inflow space 168 formed between side plate 162, injection plate 164, and the top of process chamber 10. In one embodiment, injection member 160 includes at least two, stacked injection members.

Exhaust member 20 is coupled with the bottom of process chamber 10. Exhaust member 20 is adapted to exhaust reactive byproducts from process chamber 10 and maintain process chamber 10 at a desired process pressure. In one embodiment, exhaust member 20 comprises connected exhaust pipes 220 and 240, valve assemblies 300 and 400, a trap 260, and a vacuum pump 280.

Connected exhaust pipes 220 and 240 include a first exhaust line 220 and a second exhaust line 240. First exhaust line 220 is coupled to the bottom of process chamber 10. Since first exhaust line 220 is disposed perpendicular to the bottom of process chamber 10, downward gas-stream flows readily exhaust reactive byproduct. Trap 260 is installed at the end of first exhaust line 220. Trap 260 traps any reactive byproducts particles dropping into first exhaust line 220 from process chamber 10, such as those commonly generated during routine cleaning procedures applied to process chamber 10. Trap 260 may be installed on second exhaust line 240 as well as on first exhaust line 220.

Second exhaust line 240 branches at an angle from first exhaust line 220. In the illustrated embodiment, second exhaust line 240 comprises a first line 242 and a second line 244. First line 242 is perpendicularly connected to first exhaust line 220. Thus, assuming that first exhaust line 240 extends vertically from the bottom of process chamber 10, first line 242 will extend in a horizontal direction relative to the position of process chamber 10. Alternatively, first line 242 may branch from first exhaust line 220 at an acute or obtuse angle. Further, first line 242 may have a curved or bent shape along its length.

In the illustrated example, second line 244 is perpendicularly connected to first line 242 and extends vertically away from process chamber 10. Here again, however, second line 244 may branch from first line 242 at an acute or obtuse angle, and/or may have a curved or bent shape along its length.

Pump 280 is connected to second line 244 and is adapted to forcibly extract reactive byproducts from process chamber 10.

Valve assemblies 300 and 400 comprise, respectively, a switch valve 300 adapted to open and close a flow path for gases traversing exhaust pipes 220 and 240, and a flow control valve 400 adapted to control the flow rate at which gases flow through the exhaust pipes 220 and 240.

According to one embodiment of the invention, valve assemblies 300 and 400 are connected along the length of second exhaust line 240. So connected, switch valve 300 and/or flow control valve 400 can not be contaminated by reactive byproduct particles shed from the inner sidewalls of process chamber 10 during cleaning. This arrangement prevents valves assemblies 300 and 400 from malfunctioning due to reactive byproduct particle contamination.

In one embodiment, switch valve 300 is mounted between (e.g., connects at a right angle) first line 242 and second line 244. In contrast, flow control valve 400 is connected along the length of second line 244.

As illustrated in FIG. 2, the conventional switch valve 730 comprises a cutoff plate 744 slidingly inserted within a holding space 736 extending (of necessity) perpendicularly from the main flow path provided by exhaust pipe 720. However, in such a case where the movement path of cutoff plate 734 is narrow (i.e., open/close fit tolerances are small), the movement of cutoff plate 734 may become impeded when a large quantity of reactive byproduct is deposited on inner walls of switch valve 730. However, switch valve 300 of FIG. 5, as employed within an embodiment of the invention, may have a very different form and structure. For example, switch valve 300 may include a cutoff plate adapted to move in parallel with the gas flow provided by the exhaust pipe.

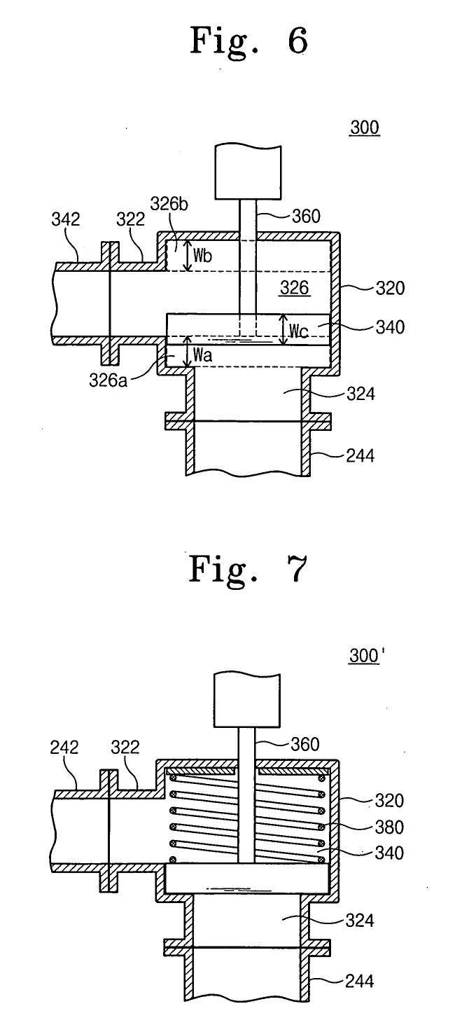

FIG. 6 is a cross-sectional view further illustrating an exemplary switch valve 300 adapted for use in the apparatus illustrated in FIG. 5. Switch valve 300 is disposed between, and at a right angle in the illustrated example, between first line 242 and second line 244. Switch valve 300 generally comprises a body 320 and a cutoff plate 340 fitted within the body 320. In one embodiment, body 320 has a cylindrical shape defining a space 326. A first valve port 322 is formed at a lateral face of the body 320, and a second valve port 324 is formed at a bottom face thereof. First line 242 is connected to first valve port 322, and second line 244 is connected to second valve port 324.

Cutoff plate 340 is seated within space 326 and is adapted to move up and down between a cutoff position 326a and an open position 326b by action of a connected driving means. In the cutoff position 326a, cutoff plate 340 is seated at a lower position generally capping first port 322 to prevent the flow of gas there-through. In the open position 326b, cutoff plate 340 is released to an upper position within body 320 allowing gas to flow. In the illustrated example, heights Wₐ and W_{b} define spaces at the upper and lower positions of a cutoff plate 340 having width W_{c} within body 320.

The driving means may take many different forms, but in the illustrated example a pneumatic cylinder is connected to a rear side of cutoff plate 340 through a hole formed at the top of body 320. By action of this pneumatic cylinder, cutoff plate 340 moves move up and down within body 320. If cutoff plate 340 moves down to the cutoff position 326a, it blocks the inlet to second line 244 and cuts off a flow of fluid. If the cutoff plate 340 moves up to the open position 326b, fluid may pass from first line 242 to second line 244. An O-ring (not shown) may be installed at the lateral face of cutoff plate 340 to seal upper and lower spaces of cutoff plate 340 from each other. With this arrangement, cutoff plate 340 may yet move freely in spite of any reactive byproducts deposited on the inner sidewalls of switch valve 300.

Alternatively, as illustrated in FIG. 7, a switch valve 300′ comprises a flexible substance 380 such as a spring. One end of spring 380 is fixed to a top surface of body 320, and the other end is fixed to the top of cutoff plate 340. When cutoff plate 340 is disposed in cutoff position 326a, spring 340 may be in an equilibrium or pressed state. Accordingly, cutoff plate 340 moves to cutoff position 326a by means of an elastic force provided by spring 380 to cut off the flow of fluid through switch valve 300′. Using either of these illustrated or similar methods, switch valve 300 may be maintained in a closed state during a cleaning process.

As described above, cutoff plate 340 moves in parallel with angle of extension of second line 244 to block the inlet of second line 244 when switch valve 300 is closed. Nevertheless, it will be understood that cutoff plate 340 might alternately be configured to move in parallel with the angle of first line 242 to block the outlet of first line 242 when switch valve 300 is closed.

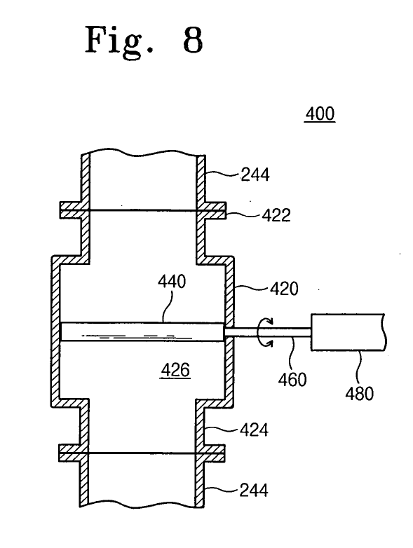

FIG. 8 is a cross-sectional view of a flow control valve 400 adapted for use in the apparatus illustrated in FIG. 5. Flow control valve 400 generally comprises a body 420 and a rotation plate 440. In one embodiment, body 420 has a cylindrical body defining a space 426 having an open top and an open bottom. Valve ports 422 and 424 are associated with the top and bottom surfaces of body 420, respectively. Using valve ports 422 and 424, flow control valve 400 may be coupled in line with second line 244. Rotation plate 440 is disposed at the center of space 426 within body 420 and in the illustrated embodiment comprises a cylindrical plate having a diameter that is slightly smaller than the inside diameter of body 420. A rotation rod 460 rotated by a motor 480 is coupled with one side of rotation plate 440. In this manner, or similarly, rotation plate 440 may be rotated within space 426. An open ratio of a fluid flow path is controlled based on a rotation angle for rotation plate 440. Although flow control valve 400 is shown mounted on second line 244, it might alternatively be mounted on first line 242.

According to embodiments of the present invention, an exhaust pipe is formed from a first exhaust line 220 disposed to be perpendicular to the bottom of a process chamber and a second exhaust line 240 connected at an angle (e.g., perpendicular) to first line 220. Switch valve 300 and the flow control valve 400 are mounted on second exhaust line 240. Thus, although reactive byproducts deposited on the inner sidewall of process chamber 10 may drop from process chamber 10 during a cleaning process, they do not adversely effect second exhaust line 240 or the components connected thereto (e.g., switch valve 300 and/or flow control valve 400).

In the above-described embodiments, a second exhaust line 240 branches from a first exhaust line 220 and a trap 260 is installed at a lower point along first exhaust line 220. Alternatively, a second exhaust line 240 may be directly connected to the lowest extension of the first exhaust line 220. However, in such cases, reactive byproducts dropping into first exhaust line 220 may be received into switch valve 300 or the flow control valve 400. Thus, second exhaust line 240 is preferably installed as a branching line somewhere along the length of first exhaust line 220.

Also, in the above-described embodiments, second exhaust line 240 comprises first line 242 and second line 244. Alternatively, second exhaust line 240 may comprise only first line 242, and switch valve 300 and flow control valve 400 may be directly mounted on first line 242.

The present invention may be variously embodied, and its scope is defined by the appended claims.

What is claimed is:

1. A substrate treating apparatus comprising:
a process chamber, and an exhaust member coupled to the process chamber and adapted to exhaust reactive byproducts from the process chamber;
wherein the exhaust member comprises:
a first exhaust line connected to and extending from the bottom of the process chamber;
a second exhaust line coupled at an angle to the first exhaust line; and
a valve assembly mounted on the second exhaust line and adapted to open and close a flow path within the second exhaust line or control a flow rate for fluid flowing along the flow path.

2. The substrate treating apparatus of claim 1, wherein the second exhaust line comprises:
a first line connected to the first exhaust line; and
a second line connected at an angle to the first line.

3. The substrate treating apparatus of claim 2, wherein the valve assembly comprises a switch valve adapted to open and close the flow path within the second exhaust line,
wherein the switch valve comprises:
a body having a lateral face associated with a first port and a bottom face associated with a second port, wherein the first line is connected to the first port and a second line is connected to the second port; and
a cutoff plate disposed within the body and adapted to move in parallel with either the extension of the first line or the second line to open/close, respectively, an outlet of the first line or an inlet of the second line.

4. The substrate treating apparatus of clam 3, wherein the valve assembly further comprises an elastic member coupled with the cutoff plate.

5. The substrate treating apparatus of claim 2, wherein the valve assembly comprises a flow control valve mounted on the second line and adapted to control the flow rate for fluid flowing along the flow path.

6. The substrate treating apparatus of claim 5, wherein the flow control valve comprises:
a body connected along the length of the second line and adapted to pass fluid along the flow path; and
a rotation plate disposed in the flow path and adapted to control an open ratio of the flow path in accordance with its rotation.

7. The substrate treating apparatus of claim 1, wherein the second exhaust line branches at a right angle along the length of the first exhaust line; and
wherein the apparatus further comprises; a trap installed at the end of the length of the first exhaust line and adapted to trap reactive byproducts dropping through the first exhaust line.

8. The substrate treating apparatus of claim 1, being an apparatus is adapted to perform a deposition process depositing thin films on a substrate.

9. A substrate treating apparatus comprising:
a process chamber adapted to perform a deposition process, and an exhaust member adapted to exhaust reactive byproducts from the process chamber;
wherein the exhaust member comprises:
a first exhaust line connected to and extending vertically from the bottom of the process chamber;
a second exhaust comprising; a first line connected at a right angle to the first exhaust line and extending horizontally, and a second line connected at a right angle to the first line and extending vertically; and
a valve assembly mounted on the second exhaust line and adapted to open/close a flow path along the second exhaust line or control a flow rate of fluid flowing along the flow path.

10. The substrate treating apparatus of claim 9, wherein the valve assembly comprises a switch valve, the switching valve comprising:
a body having a lateral face associated with a first port and a bottom face associated with a second port facing at a right angle to the first port, wherein the first line is connected to the first port and a second line is connected to the second port; and
a cutoff plate disposed within the body and adapted to move in parallel with either the extension of the first line or the second line to open/close, respectively, an outlet of the first line or an inlet of the second line.

11. The substrate treating apparatus of claim 9, wherein the second exhaust line branches along the length of the first exhaust line; and
wherein the apparatus further comprises; a trap installed at the end of the length of the first exhaust line and adapted to trap reactive byproducts dropping through the first exhaust line.

12. The substrate treating apparatus of claim 9, wherein the valve assembly further comprises a flow control valve adapted to control a flow rate for fluid flowing along the flow path.

13. The substrate treating apparatus of claim 12, wherein the flow control valve comprises:
a body connected along the length of the second line and adapted to pass fluid along the flow path; and
a rotation plate disposed in the flow path and adapted to control an open ratio of the flow path in accordance with its rotation.
